(19) United States
(12) Patent Application Publication
(10) Pub. No.: US 2025/0314554 A1
(43) Pub. Date: Oct. 9, 2025

(54) FACILITATING INSPECTION OF STRUCTURAL FEATURES OF AN OPTICAL CONNECTOR

(71) Applicant: VIAVI Solutions Inc., Chandler, AZ (US)

(72) Inventors: Jay Gregory BRACE, Lynnwood, WA (US); Kevin CASSADY, Monroe, WA (US); Maciej ZIOMKOWSKI, Bothell, WA (US); Andrew PARSONS, Brier, WA (US)

(21) Appl. No.: 18/629,791

(22) Filed: Apr. 8, 2024

(51) Int. Cl. G01M 11/08; G02B 6/38

(52) U.S. Cl. CPC G01M 11/088; G02B 6/385

(57) ABSTRACT

A device for inspecting a set of one or more optical fibers included in an optical cable includes a microscope; one or more adjustment components; and one or more processors. The one or more processors determine that an optical connector is connected to the optical cable and identify a structural feature of the optical connector. The one or more processors cause the one or more adjustment components to adjust the microscope to a particular position such that the structural feature of the optical connector is within an on-axis region of a field of view of a lens of the microscope, and thereby cause a camera of the microscope to obtain one or more images associated with the structural feature of the optical connector. The one or more processors analyze the one or more images to generate assessment information associated with the structural feature and then provide the assessment information.

### BACKGROUND

A microscope may include an instrument used to see objects that are too small to be seen by the naked eye. Microscopy may include investigating small objects and structures using a microscope. A microscope may be used to view and inspect optical fibers of an optical cable.

### SUMMARY

In some implementations, a device for inspecting a set of one or more optical fibers included in an optical cable includes a microscope; one or more adjustment components; and one or more processors configured to: determine that an optical connector is connected to the optical cable; identify a structural feature of the optical connector; cause, based on identifying the structural feature, the one or more adjustment components to adjust the microscope to a particular position such that the structural feature of the optical connector is within an on-axis region of a field of view of a lens of the microscope; cause, based on causing the one or more adjustment components to adjust the microscope to the particular position, a camera of the microscope to obtain one or more images associated with the structural feature of the optical connector; analyze, using a first set of one or more analysis techniques, the one or more images to generate assessment information associated with the structural feature of the optical connector; and provide the assessment information.

In some implementations, a device for inspecting a set of one or more optical fibers included in an optical cable includes a microscope; one or more processors configured to: identify a structural feature of an optical connector that is connected to the optical cable; cause, based on identifying the structural feature, adjustment of the microscope to a particular position such that the structural feature of the optical connector is within an on-axis region of a field of view of a lens of the microscope; cause, based on causing the adjustment of the microscope to the particular position, a camera of the microscope to obtain one or more images associated with the structural feature of the optical connector; analyze the one or more images to generate assessment information associated with the structural feature of the optical connector; and provide the assessment information.

In some implementations, a method includes causing, by a device for inspecting a set of one or more optical fibers included in an optical cable, adjustment of a microscope of the device to a particular position such that a structural feature of an optical connector that is connected to the optical cable is within an on-axis region of a field of view of a lens of the microscope; analyzing, by the device and based on causing the adjustment of the microscope to the particular position, one or more images obtained by a camera of the microscope to generate assessment information associated with the structural feature of the optical connector; and providing, by the device, the assessment information.

### BRIEF DESCRIPTION OF THE DRAWINGS

FIGS. 1A-1C are diagrams of one or more example implementations described herein.

FIGS. 2A-2C are diagrams of one or more example implementations of an optical connector.

FIGS. 3A-3B are diagrams of one or more example implementations of an optical connector.

FIG. 4 is a diagram of example components of a device associated with some implementations described herein.

FIG. 5 is a flowchart of an example process associated with analysis of structural features of an optical connector.

### DETAILED DESCRIPTION

The following detailed description of example implementations refers to the accompanying drawings. The same reference numbers in different drawings may identify the same or similar elements.

A technician may use a device, such as a handheld optical fiber microscope, to inspect an end face of an optical fiber of an optical cable prior to connecting the optical cable to network equipment. For example, the optical fiber may be placed in a field of view of the device, and the device may capture images of an end face of the optical fiber so that the device (and/or another device) may analyze the images for dirt particles, dust particles, scratches, and/or other surface defects. The device may need to capture a high-quality image of the end face of the optical fiber in order to perform an accurate analysis of the end face. For example, in order to enable an accurate analysis of the end face, the end face should be centered in the image so that any dirt particles, dust particles, scratches, fingerprints, debris, and/or other surface defects are able to be detected when the image of the end face is analyzed.

In some cases, such as when the optical cable is attached to an optical connector (e.g., to terminate the optical cable), there are additional features (e.g., of the optical connector) that should be inspected to determine whether the optical cable can properly connect to other network equipment and/or whether the optical fiber of the optical cable is able to properly interface with another optical fiber (e.g., of another optical cable). However, in many cases, the device described above is not configured to capture an image of these additional features, or is only able to capture low-quality images of the additional features, such as where the additional features are located at a periphery of the images (e.g., the additional features are not centered in the images). This makes inspecting the additional features difficult, if not impossible. Consequently, additional features of the optical connector that are damaged, malformed, dirty, or otherwise nonoptimal are often overlooked and unaddressed, and thus the optical connector degrades a performance of the optical cable and the optical fiber of the optical cable (e.g., when connected to another optical cable).

Some implementations described herein include a device that includes a microscope, one or more adjustment components, and one or more processors. A technician can use the device to inspect an optical cable that includes a set of one or more optical fibers and to inspect an optical connector that is connected to the optical cable. For example, the one or more processors can cause the microscope to adjust to a particular position such that the particular optical fiber is within an on-axis region of a field of view of a lens of the microscope. This allows a camera of the microscope to obtain one or more images associated with the particular optical fiber (e.g., where the particular optical fiber is centered in the one or more images), which thereby enables the one or more processors to analyze the one or more images to generate and provide assessment information associated with the particular optical fiber. Further, the one or more processors can cause the microscope to adjust to a particular position such that a structural feature of the optical connector (e.g., an attachment component of the optical connector, an edge of a ferrule of the optical connector, among other examples) is within the on-axis region of the field of view of the lens of the microscope. This allows the camera of the microscope to obtain one or more images associated with the structural feature (e.g., where the structural feature is centered in the one or more images), which thereby enables the one or more processors to analyze the one or more images to generate and provide assessment information associated with the structural feature.

The on-axis region of the field of view of the lens of the microscope is a central portion of the field of view that lies along an optical axis of the lens. Accordingly, light associated with the on-axis region of the field of view of the lens passes through the center of the lens (e.g., along the optical axis) with minimal distortions or aberrations. Thus, when the microscope is “pointed at” the structural feature of the optical connector (e.g., such that the structural feature of the optical connector is within the on-axis region of the field of view of the lens of the microscope), light from the structural feature passes to the camera of the microscope with minimal distortions or aberrations and the camera is able to obtain one or more high-quality (i.e., accurate) images of the structural feature. The one or more processors are thereby able to analyze the one or more high-quality images to generate and provide high-quality assessment information (e.g., that accurately identifies whether the structural feature is damaged, malformed, dirty, or otherwise nonoptimal). Obtaining high-quality assessment information related to a structural feature of an optical connector is not otherwise possible using current inspection techniques.

In this way, the device enables a technician or other user to determine a condition of a structural feature of an optical connector quickly and easily. Accordingly, an issue associated with the structural feature can be identified and addressed, which enables the optical connector to improve a performance of the optical cable and the optical fiber of the optical cable (e.g., when connected to another optical cable). Further, computing resources (e.g., processing resources, memory resources, communication resources, and/or power resources, among other examples) of the device that would otherwise be used to capture, store, view, analyze, and/or otherwise use low quality images of the structural feature (e.g., where the structural feature was not within the on-axis region of the field of view of the lens of the microscope) are conserved.

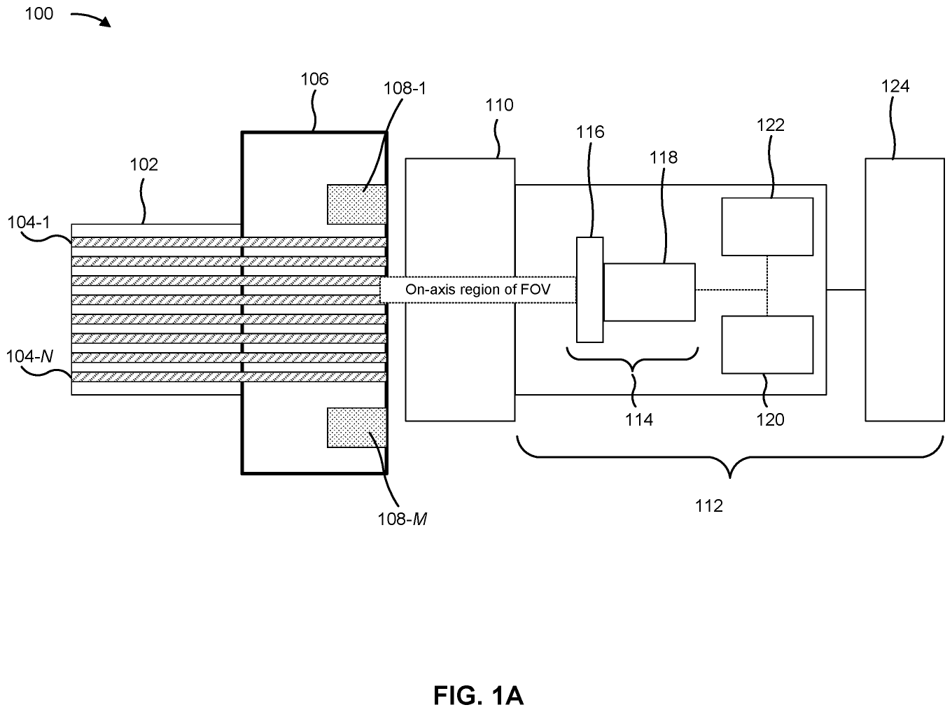

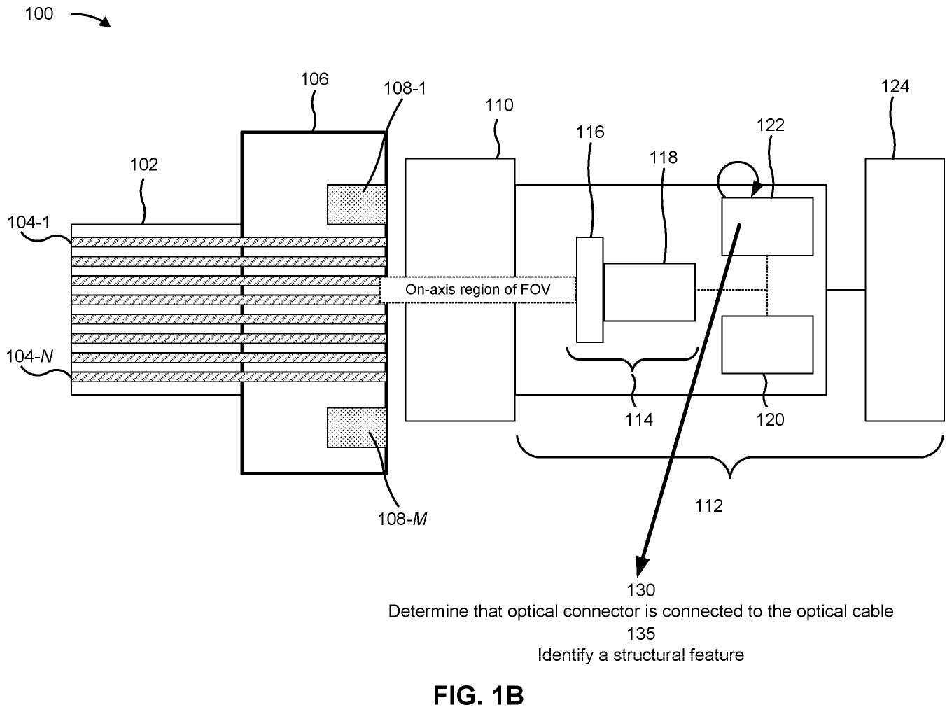

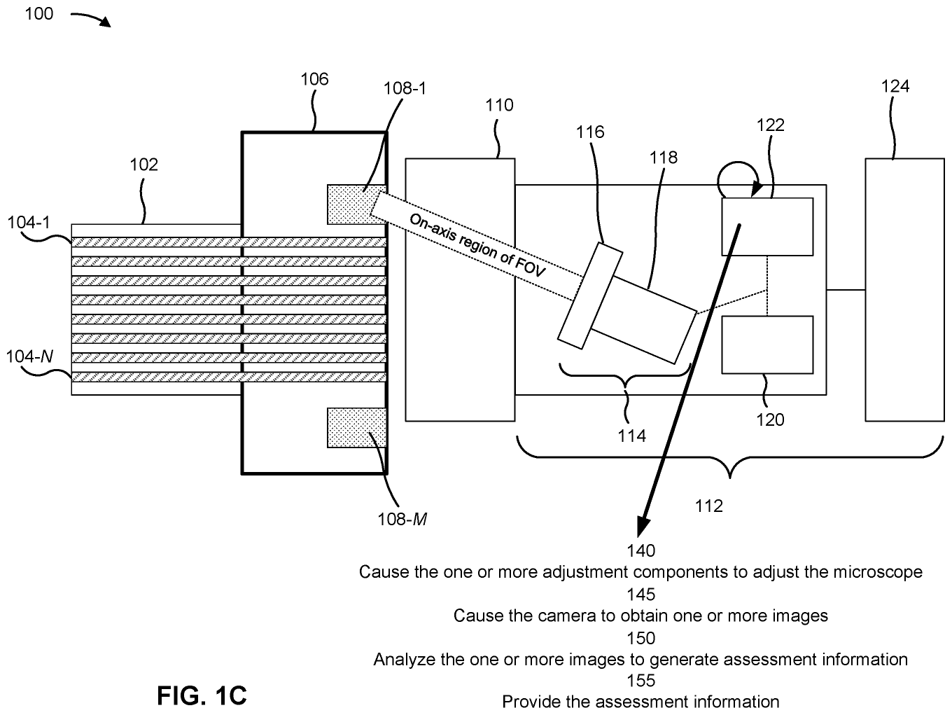

FIGS. 1A-1C are diagrams of one or more example implementations 100 described herein. As shown in FIG. 1A, example implementation(s) 100 may include an optical cable 102 that includes a set of one or more optical fibers 104 (shown as optical fibers 104-1 through 104-N, where N≥1), an optical connector 106 that includes one or more structural features 108 (shown as structural features 108-1 through 108-M, where M≥1), a tip 110, and a device 112 (e.g., an optical fiber inspection device) that includes a microscope 114 (e.g., comprising a lens 116 and a camera 118), one or more adjustment components 120, one or more processors 122, and/or a display screen 124.

The optical cable 102 may include the set of one or more optical fibers 104. For example, an optical fiber 104 may be disposed within a central region of the optical cable 102, along a length of the optical cable 102. As another example, the optical cable 102 may include a plurality of optical fibers 104 arranged in an optical fiber package that is disposed within the central region of the optical cable 102, along the length of the optical cable 102. The plurality of optical fibers 104 may be arranged, for example, in a one-dimensional array or a two-dimensional array within the optical fiber package (e.g., in a cross-section view of the optical fiber package). In some implementations, the optical cable 102 may include a ferrule comprising metal, ceramic, high-quality plastic, and/or the like, and the ferrule may have a hollowed-out center that holds and/or grips the set of one or more optical fibers 104.

The optical connector 106 may be attached to the optical cable 102. For example, the optical connector 106 may be connected to an end surface of the optical cable 102. The optical connector 106 may include any type of fiber optic connector, such as a fiber-optic connector (FC), an FC/physical content (PC) connector, an FC/angled physical content (APC) connector, a snap-in connector (SC), a straight tip (ST) connector, a multiple fiber push-on/pull-off (MPO) connector, and/or a little connector (LC), among other examples. In some implementations, the optical connector 106 may include one or more structural features 108. For example, as shown in FIGS. 1A-1C, the optical connector 106 may include one or more structural features 108-1 through 108-M. A structural feature 108 may include, for example, an attachment component of the optical connector (e.g., a pin or a hole, such as to facilitate alignment of the optical connector 106 with another optical connector 106 during connection of the two optical connectors 106), or an edge of a ferrule of the optical connector 106, among other examples. Examples of structural features 108 are further described herein in relation to FIGS. 1A-1C.

The set of one or more optical fibers 104 of the optical cable 102 may extend from the end surface of the optical cable 102 and into the optical connector 106. For example, each optical fiber 104 may extend into and terminate within the optical connector 106, with an end face that is exposed within the optical connector 106. The end face may be angled (e.g., at a non-zero angle to a longitudinal axis of the optical fiber 104). The end face may be, for example, polished at a precise angle, such as eight degrees (e.g., within a tolerance of 1 degree). In some implementations, the optical connector 106 may include a single ferrule (e.g., comprising metal, ceramic, high-quality plastic, and/or the like) that holds and/or grips the set of one or more optical fibers 104. Alternatively, the optical connector 106 may include a plurality of ferrules, wherein each ferrule holds and/or grips a subset of the set of one or more optical fibers 104.

As further shown in FIGS. 1A-1C, example implementation(s) 100 may include the device 112 (e.g., an optical fiber inspection device, such as an optical fiber microscope) and the tip 110 (e.g., an inspection tip, such as for an optical fiber inspection device). The device 112 may include one or more components to capture and/or analyze an image or video of an end face of an optical fiber 104, of the set of one or more optical fibers 104 included in the optical cable 102 and the optical connector 106 (e.g., when the optical connector 106 is connected to the optical cable 102), and/or a structural feature 108 of the optical connector 106. For example, the device 112 may include (e.g., housed within the device 112) one or more optical components, such as the microscope 114 that includes the lens 116 and the camera 118; the one or more adjustment components 120; the one or more processors 122; and/or the display screen 124. The tip 110 may be configured to connect to the device 112 and to attach to, or to insert into, the optical connector 106 to allow the microscope 114 to be positioned near the end faces of the set of one or more optical fibers 104 and/or near the one or more structural features 108 of the optical connector 106.

The lens 116 may comprise glass, a polymer, or another type of material configured to collect and focus light. The lens 116 may have a particular magnification power, or a range of magnification powers. The lens 116 may have an optical axis (e.g., an imaginary line that passes through the center of the lens 116) and may have a field of view (e.g., that defines an extent of a scene captured by the lens 116) that is associated with the optical axis (e.g., a “width” of the field of view of the lens 116 may be expressed as an angular measurement with respect to the optical axis). Accordingly, the lens 116 may include an on-axis region of the field of view (e.g., a central portion of the field of view that lies along the optical axis of the lens 116). Light associated with the on-axis region of the field of view of the lens 116 may pass through the center of the lens 116 (e.g., along the optical axis) with minimal distortions or aberrations.

The camera 118 may include an image sensor such as a charge-coupled device (CCD) sensor, a complementary metal-oxide semiconductor (CMOS) sensor, and/or another type of image sensor. The camera 118 (e.g., the image sensor of the camera 118) may convert light (e.g., that is directed to the camera 118 by the lens 116) into image data. The image data may include, for example, one or more images (e.g., as single, standalone images, or as a continuous stream of images associated with video) or other image information related to a subject in the field of view of the lens 116.

The one or more adjustment components 120 may include one or more motors (e.g., one or more step motors), one or more shafts (e.g., that are extendable and/or retractable), one or more cams, one or more gears, and/or one or more other types of adjustment components. The one or more adjustment components 120 may be configured to adjust a position of the microscope 114 (e.g., relative to one or more rectilinear axes of the device 112). For example, the one or more adjustment components 120 may be configured to adjust a position of the microscope (e.g., relative to a horizontal axis of the device 112 and/or a vertical axis of the device 112, shown in FIGS. 1A-1C) such that a particular region of the optical cable 102 and/or of the optical connector 106 is within the on-axis region of the field of view of the lens 116 of the microscope 114. That is, the one or more adjustment components 120 may be configured to cause the microscope 114 to “point at” the particular region of the optical cable 102 and/or of the optical connector 106 (e.g., by causing the microscope 114 to pivot, to shift, to pan, or to perform another type of movement), such as to enable light associated with the particular region of the optical cable 102 and/or of the optical connector 106 to propagate to and pass through the center of the lens 116 (e.g., along the optical axis of the lens 116) with minimal distortions or aberrations (e.g., to the camera 118 of the microscope 114).

The one or more processors 122 may be configured to control and/or to communicate with one or more components of the device (e.g., the microscope 114, the one or more adjustment components, and/or the display screen 124). For example, the one or more processors 122 may be configured to perform one or more operations described herein in association with FIGS. 1B-1C.

The display screen 124 may include any type of display screen (e.g., a non-interactive display screen, an interactive display screen, or another type of display screen), or another type of device, that visually, audibly, and/or haptically presents information (e.g., to an observer). The display screen 124 may be sized and/or positioned such that an operator of the device 112 may observe the display screen 124 in association with using the device 112, as described herein.

As shown in FIG. 1B, and by reference number 130, the one or more processors 122 of the device 112 may determine that the optical connector 106 is connected to the optical cable 102. For example, the operator of the device 112 may input, such as via the display screen 124 and/or an input component of the device 112, an indication that the optical connector 106 is connected to the optical cable 102. As another example, the device 112, via the tip 110, may contact, or otherwise interface with, the optical connector 106 and may thereby determine that the optical connector 106 is connected to the optical cable 102.

As shown by reference number 135, the one or more processors 122 of the device 112 may identify a structural feature 108 of the optical connector 106 (e.g., the structural feature 108-1 shown in FIG. 1B). For example, the one or more processors 122 may cause the camera 118 of the microscope 114 to obtain one or more images of the optical connector 106 and may analyze (e.g., using a set of one or more analysis techniques, such as for identifying structural features of an optical connector) the one or more images to identify the structural feature 108. As another example, the operator of the device 112 may input, such as via the display screen 124 and/or an input component of the device 112, information identifying the structural feature 108 (e.g., information identifying a type of the optical connector 106 and/or a position of the structural feature 108 on the optical connector 106).

As shown in FIG. 1C, and by reference number 140, the one or more processors 122 of the device 112 may cause the one or more adjustment components 120 to adjust the microscope 114 (e.g., based on identifying the structural feature 108). For example, the one or more processors 122 of the device 112 may cause the one or more adjustment components 120 to adjust the microscope 114 to a particular position such that the structural feature 108 of the optical connector 106 is within the on-axis region of the field of view of the lens 116 of the microscope 114. That is, the one or more processors 122 of the device 112 may cause the one or more adjustment components 120 to adjust the microscope 114 to cause the microscope 114 to point at the structural feature 108.

As shown by reference number 145, the one or more processors 122 of the device 112 may cause the camera 118 of the microscope 114 to obtain one or more images associated with the structural feature 108 of the optical connector 106 (e.g., based on causing the one or more adjustment components 120 to adjust the microscope 114 to the particular position). For example, the one or more processors 122 may send one or more commands to the camera 118 to obtain one or more images. Because the microscope 114 is in the particular position (e.g., because the microscope 114 is pointed at the structural feature 108 of the optical connector 106), the one or more images may be associated with the structural feature 108 of the optical connector 106 (e.g., the one or more images may show light that originated from the structural feature 108). Further, each image, of the one or more images, may include a region associated with the on-axis region of the field of view of the lens 116 of the microscope 114. Accordingly, the region of the image may show the structural feature 108 of the optical connector 106. In some implementations, the region of the image may not show any of the set of one or more optical fibers 104 of the optical cable 102 (e.g., because the region of the on-axis region of the field of view of the lens 116 of the microscope 114 encompasses only the structural feature 108, and therefore the region of the image only shows the structural feature 108). Alternatively, the region of the image may show at least a portion of one optical fiber 104 (e.g., an optical fiber adjacent to the structural feature 108, such as optical fiber 104-1 that is adjacent to structural feature 108-1, as shown in FIG. 1C) of the set of one or more optical fibers 104 of the optical cable 102 (e.g., because the region of the on-axis region of the field of view of the lens 116 of the microscope 114 encompasses the structural feature 108 and the portion of the one optical fiber 104, and therefore the region of the image shows the structural feature 108 and the portion of the one optical fiber 104).

As shown by reference number 150, the one or more processors 122 of the device 112 may analyze the one or more images to generate assessment information associated with the structural feature 108 of the optical connector 106. The one or more processors 122 of the device 112 may analyze the one or more images using a set of one or more analysis techniques, such as to assess whether the structural feature 108 is damaged, malformed, dirty, and/or otherwise nonoptimal. Accordingly, the assessment information may indicate whether the structural feature 108 is damaged, malformed, dirty, and/or otherwise nonoptimal.

As shown by reference number 155, the one or more processors 122 of the device 112 may provide the assessment information. For example, the one or more processors 122 of the device 112 may send the assessment information to the display screen 124, which may allow the display screen 124 to display at least a portion of the assessment information. As a specific example, the one or more processors 122 of the device 112 may send the assessment information to the display screen 124 in association with sending the one or more images to the display screen 124. This may allow the display screen 124 to display at least a portion of the assessment information (e.g., as a text overlay and/or an image overlay) when displaying the one or more images.

In some implementations, the one or more processors 122 of the device 112 may perform one or more of the operations described herein (e.g., in relation to FIGS. 1B-1C) with respect to another structural feature 108 of the optical connector 106.

For example, the one or more processors 122 of the device 112 may identify another structural feature 108 of the optical connector 106 (e.g., the structural feature 108-M shown in the FIG. 1A-1C), in a same or similar manner as that described herein in relation to FIG. 1B and reference number 135. The one or more processors 122 of the device 112 may cause (e.g., based on identifying the other structural feature 108) the one or more adjustment components 120 to adjust the microscope 114 to another particular position such that the other structural feature 108 of the optical connector 106 is within the on-axis region of the field of view of the lens 116 of the microscope 114, in a same or similar manner as that described herein in relation to FIG. 1C and reference number 140. That is, the one or more processors 122 of the device 112 may cause the one or more adjustment components 120 to adjust the microscope 114 to cause the microscope 114 to point at the other structural feature 108.

The one or more processors 122 of the device 112 then may cause (e.g., based on causing the one or more adjustment components 120 to adjust the microscope 114 to the other particular position) the camera 118 of the microscope 114 to obtain one or more other images associated with the other structural feature 108 of the optical connector 106, in a same or similar manner as that described herein in relation to FIG. 1C and reference number 145. Accordingly, each image, of the one or more other images, may include a region associated with the on-axis region of the field of view of the lens 116 of the microscope 114 and, thereby, the region of the image may show the other structural feature 108 of the optical connector 106. The region of the image may not show any of the set of one or more optical fibers 104 of the optical cable 102, or, alternatively, may show at least a portion of one optical fiber 104 (e.g., an optical fiber 104 adjacent to the structural feature 108, such as optical fiber 104-N that is adjacent to structural feature 108-M, as shown in FIGS. 1A-1C) of the set of one or more optical fibers 104 of the optical cable 102.

The one or more processors 122 of the device 112 may analyze, using a set of one or more analysis techniques (e.g., that is the same as the set of one or more analysis techniques described above, or that is a different set of one or more analysis techniques), the one or more other images to generate other assessment information associated with the other structural feature 108 of the optical connector 106, in a same or similar manner as that described herein in relation to FIG. 1C and reference number 150. Accordingly, the other assessment information may indicate whether the other structural feature 108 is damaged, malformed, dirty, and/or otherwise nonoptimal. The one or more processors 122 of the device 112 may provide the other assessment information, in a same or similar manner as that described herein in relation to FIG. 1C and reference number 150. For example, the one or more processors 122 of the device 112 may send the other assessment information to the display screen 124, which may allow the display screen 124 to display at least a portion of the other assessment information.

In some implementations, the structural feature 108 (e.g., the structural feature 108-1) and the other structural feature 108 (e.g., the structural feature 108-M) are each associated with a single ferrule of the optical connector 106 (e.g., each are included in or part of the same ferrule of the optical connector 106). Alternatively, the structural feature 108 (e.g., the structural feature 108-1) is associated with a first ferrule (e.g., included in or part of the first ferrule) and the other structural feature 108 (e.g., the structural feature 108-M) is associated with a second ferrule (e.g., included in or part of the second ferrule, which is different than the first ferrule) of the optical connector 106.

Additionally, or alternatively, the one or more processors 122 of the device 112 may perform one or more of the operations described herein (e.g., in relation to FIGS. 1B-1C) with respect to a particular optical fiber 104 of the set of one or more optical fibers 104 of the optical cable 102.

For example, the one or more processors 122 of the device 112 may identify the particular optical fiber 104 (e.g., the optical fiber 104-1 shown in the FIG. 1A-1C), in a same or similar manner as that described herein in relation to FIG. 1B and reference number 135. The one or more processors 122 of the device 112 may cause (e.g., based on identifying the particular optical fiber 104) the one or more adjustment components 120 to adjust the microscope 114 to another particular position such that the particular optical fiber 104 is within the on-axis region of the field of view of the lens 116 of the microscope 114, in a same or similar manner as that described herein in relation to FIG. 1C and reference number 140. That is, the one or more processors 122 of the device 112 may cause the one or more adjustment components 120 to adjust the microscope 114 to cause the microscope 114 to point at the particular optical fiber 104.

The one or more processors 122 of the device 112 then may cause (e.g., based on causing the one or more adjustment components 120 to adjust the microscope 114 to the other particular position) the camera 118 of the microscope 114 to obtain one or more other images associated with the particular optical fiber 104, in a same or similar manner as that described herein in relation to FIG. 1C and reference number 145. Accordingly, each image, of the one or more other images, may include a region associated with the on-axis region of the field of view of the lens 116 of the microscope 114 and, thereby, the region of the image may show the particular optical fiber 104. The region of the image may not show any structural feature 108 of the optical connector 106, or, alternatively, may show at least a portion of one structural feature 108 (e.g., a structural feature 108 adjacent to the particular optical fiber 104, such as structural feature 108-1 that is adjacent to optical fiber 104-1, as shown in FIGS. 1A-1C) of the one or more structural features 108 of the optical connector 106.

The one or more processors 122 of the device 112 may analyze, using a set of one or more analysis techniques (e.g., that is the same as the set of one or more analysis techniques described above, or that is a different set of one or more analysis techniques), the one or more other images to generate other assessment information associated with the particular optical fiber 104, in a same or similar manner as that described herein in relation to FIG. 1C and reference number 150. Accordingly, the other assessment information may indicate whether the particular optical fiber 104 is damaged, malformed, dirty, and/or otherwise nonoptimal. The one or more processors 122 of the device 112 may provide the other assessment information, in a same or similar manner as that described herein in relation to FIG. 1C and reference number 150. For example, the one or more processors 122 of the device 112 may send the other assessment information to the display screen 124, which may allow the display screen 124 to display at least a portion of the other assessment information.

In some implementations, the structural feature 108 (e.g., the structural feature 108-1) and the particular optical fiber 104 (e.g., when the particular optical fiber is the optical fiber 104-1) are each associated with a single ferrule of the optical connector 106 (e.g., each are included in or part of the same ferrule of the optical connector 106). Alternatively, the structural feature 108 (e.g., the structural feature 108-1) is associated with a first ferrule (e.g., included in or part of the first ferrule) and the particular optical fiber 104 (e.g., when the particular optical fiber is the optical fiber 104-N) is associated with a second ferrule (e.g., included in or part of the second ferrule, which is different than the first ferrule) of the optical connector 106.

As indicated above, FIGS. 1A-1C are provided as one or more examples. Other examples may differ from what is described with regard to FIGS. 1A-1C. In practice, there may be additional components, fewer components, different components, or differently arranged components than those shown in FIGS. 1A-1C.

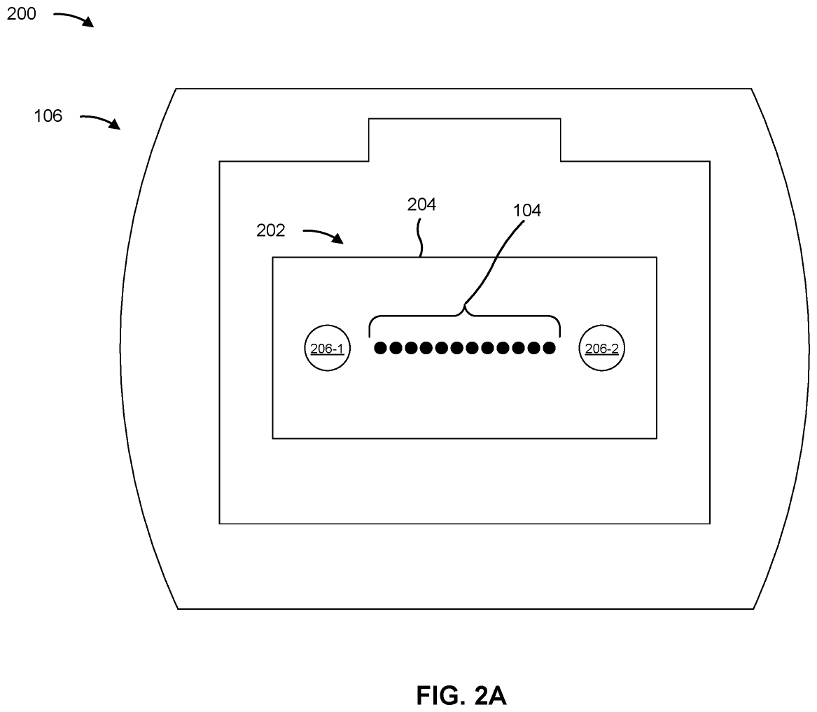

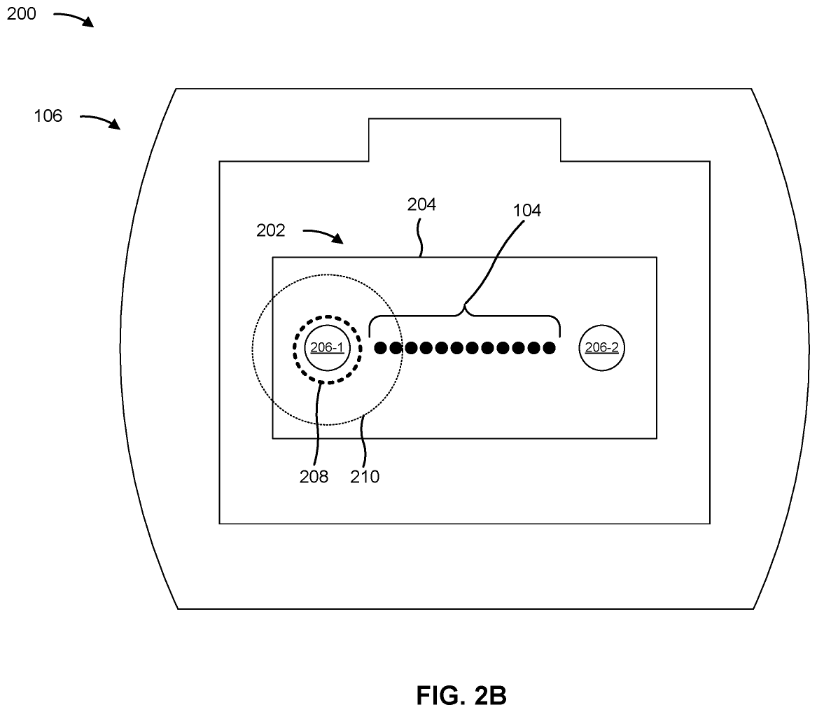

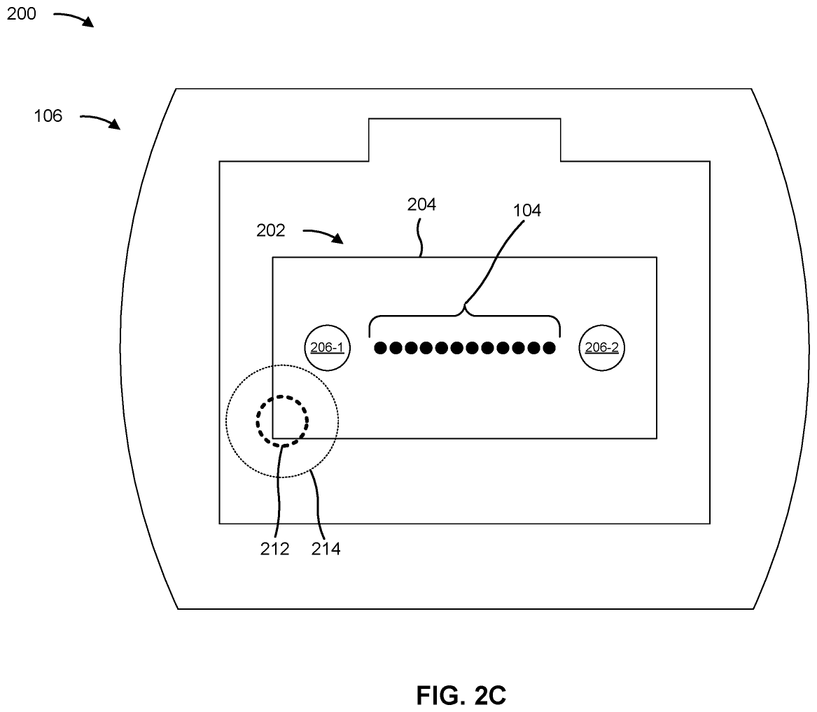

FIGS. 2A-2C are diagrams of one or more example implementations 200 of the optical connector 106. As shown in FIGS. 2A-2C, the optical connector 106 (e.g., shown as an MPO connector) may include a plurality of optical fibers 104 (e.g., that extend from an end surface of an optical cable 102, which is attached to the optical connector 106, and terminate within the optical connector 106) within a ferrule 202 (e.g., a single ferrule) of the optical connector 106. The ferrule 202 may include an edge 204 and one or more attachment components 206 (shown as attachment components 206-1 and 206-2) (e.g., pins, holes, or other types of attachment components).

In some implementations, the one or more processors 122 of the device 112 may cause the one or more adjustment components 120 to adjust the microscope 114 to a particular position such that the structural feature 108 of the optical connector 106 is within the on-axis region of the field of view of the lens 116 of the microscope 114, such as described herein in relation to FIG. 1C and reference number 140. FIG. 2B shows an example on-axis region 208 of an example field of view 210 of the lens 116 of the microscope 114 when the structural feature 108 is the attachment component 206-1. As shown in FIG. 2B, the on-axis region 208 of the field of view 210 of the lens 116 of the microscope 114 encompasses only the attachment component 206-1 (e.g., does not encompass any of the plurality of optical fibers 104). FIG. 2C shows an example on-axis region 212 of an example field of view 214 of the lens 116 of the microscope 114 when the structural feature 108 is the edge 204 of the ferrule 202. As shown in FIG. 2C, the on-axis region 212 of the field of view 214 of the lens 116 of the microscope 114 encompasses only a portion of the edge 204 (e.g., does not encompass any of the plurality of optical fibers 104).

As indicated above, FIGS. 2A-2C are provided as one or more examples. Other examples may differ from what is described with regard to FIGS. 2A-2C. In practice, there may be additional components, fewer components, different components, or differently arranged components than those shown in FIGS. 2A-2C.

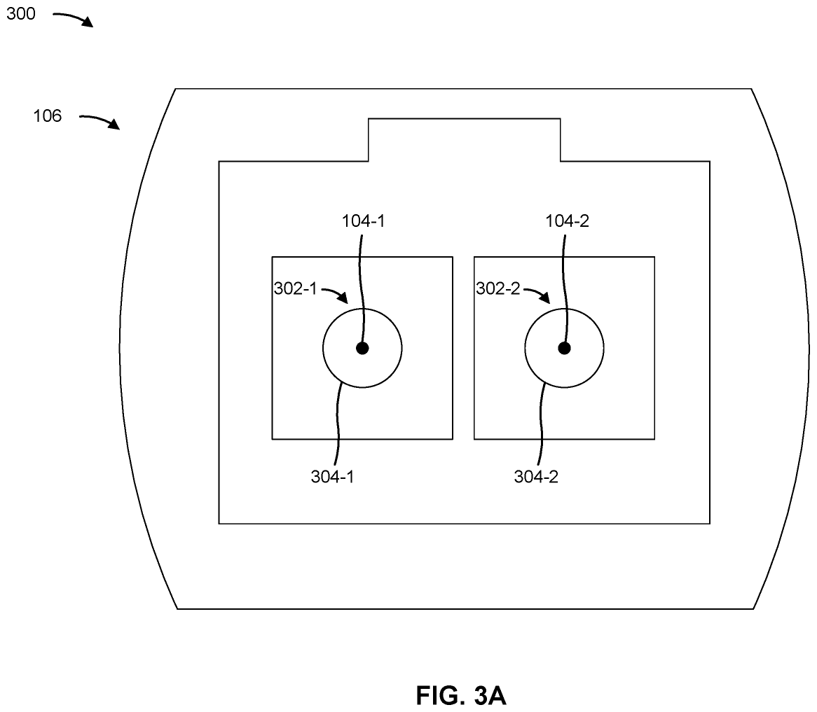

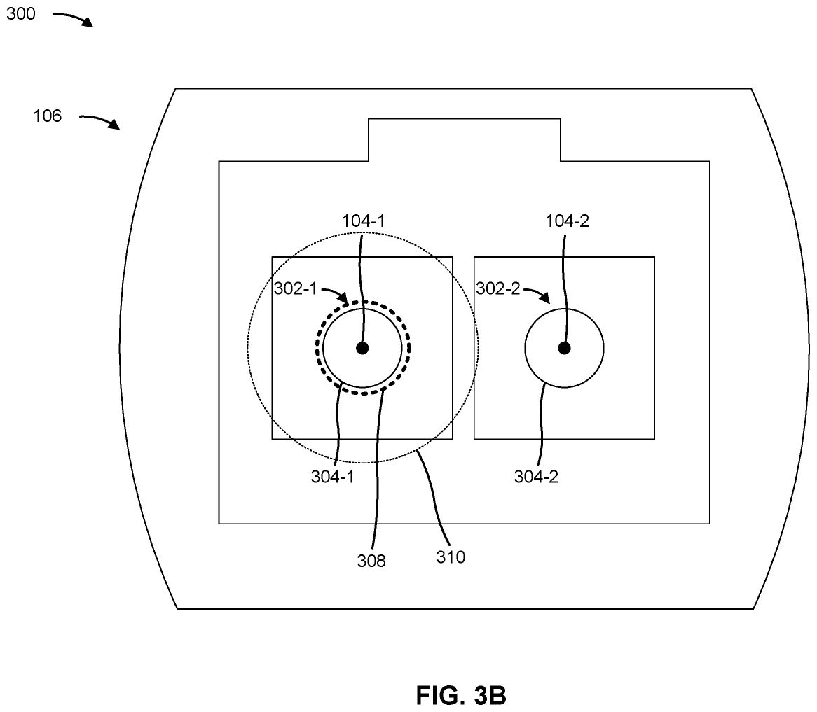

FIGS. 3A-3B are diagrams of one or more example implementations 300 of the optical connector 106. As shown in FIGS. 3A-3B, the optical connector 106 (e.g., shown as an LC duplex connector) may include a plurality of optical fibers 104 (e.g., that extend from an end surface of an optical cable 102, which is attached to the optical connector 106, and terminate within the optical connector 106), shown as optical fibers 104-1 and 104-2, within ferrules 302-1 and 302-2, respectively, of the optical connector 106. Each ferrule 302 may include an edge 304 (shown as edges 304-1 and 304-2).

In some implementations, the one or more processors 122 of the device 112 may cause the one or more adjustment components 120 to adjust the microscope 114 to a particular position such that the structural feature 108 of the optical connector 106 is within the on-axis region of the field of view of the lens 116 of the microscope 114, such as described herein in relation to FIG. 1C and reference number 140. FIG. 3B shows an example on-axis region 308 of an example field of view 310 of the lens 116 of the microscope 114 when the structural feature 108 is the edge 304-1 of the ferrule 302-1. As shown in FIG. 3B, the on-axis region 308 of the field of view 310 of the lens 116 of the microscope 114 encompasses the edge 304-1 of the ferrule 302-1 and the optical fiber 104-1 (e.g., because the ferrule 302-1 holds and/or grips the optical fiber 104-1).

As indicated above, FIGS. 3A-3B are provided as one or more examples. Other examples may differ from what is described with regard to FIGS. 3A-3B. In practice, there may be additional components, fewer components, different components, or differently arranged components than those shown in FIGS. 3A-3B.

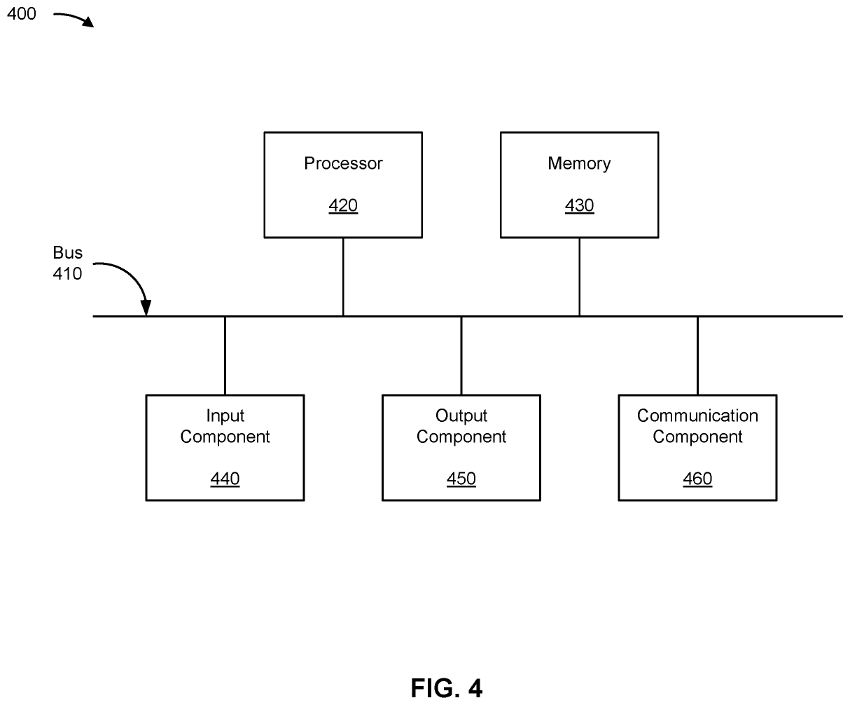

FIG. 4 is a diagram of example components of a device 400 associated with some implementations described herein. The device 400 may correspond to the device 112, the microscope 114, the camera 118, the one or more adjustment components 120, the one or more processors 122, and/or the display screen 124. In some implementations, the device 112, the microscope 114, the camera 118, the one or more adjustment components 120, the one or more processors 122, and/or the display screen 124 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

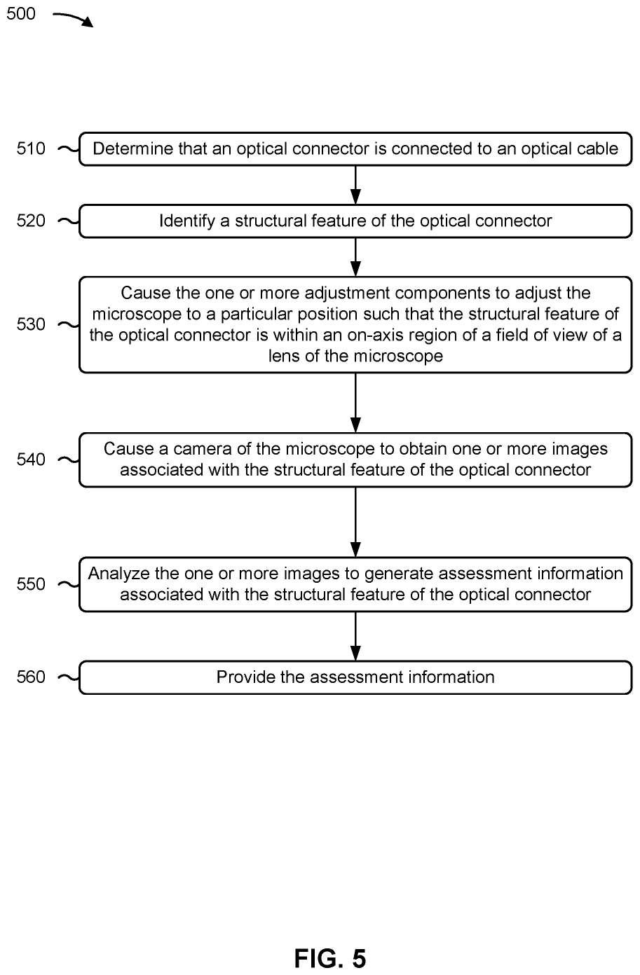

FIG. 5 is a flowchart of an example process 500 associated with analysis of structural features of an optical connector. In some implementations, one or more process blocks of FIG. 5 are performed by a device (e.g., device 112), such as by using one or more processors (e.g., one or more processors 122) of the device. The device may be for inspecting a set of one or more optical fibers in an optical cable. In some implementations, one or more process blocks of FIG. 5 are performed by another device or a group of devices separate from or including the device, such as a microscope (e.g., microscope 114), a camera (e.g., camera 118), one or more adjustment components (e.g., one or more adjustment components 120) and/or a display device (e.g., display screen 124). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include determining that an optical connector is connected to the optical cable (block 510). For example, the device may determine that an optical connector is connected to the optical cable, as described above.

As further shown in FIG. 5, process 500 may include identifying a structural feature of the optical connector (block 520). For example, the device may identify a structural feature of the optical connector, as described above.

As further shown in FIG. 5, process 500 may include causing the one or more adjustment components to adjust the microscope to a particular position such that the structural feature of the optical connector is within an on-axis region of a field of view of a lens of the microscope (block 530). For example, the device may cause the one or more adjustment components to adjust the microscope to a particular position such that the structural feature of the optical connector is within an on-axis region of a field of view of a lens of the microscope, as described above.

As further shown in FIG. 5, process 500 may include causing a camera of the microscope to obtain one or more images associated with the structural feature of the optical connector (block 540). For example, the device may cause, based on causing the one or more adjustment components to adjust the microscope to the particular position, a camera of the microscope to obtain one or more images associated with the structural feature of the optical connector, as described above.

As further shown in FIG. 5, process 500 may include analyzing the one or more images to generate assessment information associated with the structural feature of the optical connector (block 550). For example, the device may analyze, using a first set of one or more analysis techniques, the one or more images to generate assessment information associated with the structural feature of the optical connector, as described above.

As further shown in FIG. 5, process 500 may include providing the assessment information (block 560). For example, the device may provide the assessment information, as described above.

Process 500 may include additional implementations, such as any single implementation or any combination of implementations described below and/or in connection with one or more other processes described elsewhere herein.

In a first implementation, process 500 includes identifying a particular optical fiber of the set of one or more optical fibers; causing, based on identifying the particular optical fiber, the one or more adjustment components to adjust the microscope to another particular position such that the particular optical fiber is within the on-axis region of the field of view of the lens of the microscope; causing, based on causing the one or more adjustment components to adjust the microscope to the other particular position, the camera of the microscope to obtain one or more other images associated with the particular optical fiber; analyzing, using a second set of one or more analysis techniques, the one or more other images to generate other assessment information associated with the particular optical fiber; and providing the other assessment information.

In a second implementation, alone or in combination with the first implementation, process 500 includes identifying another structural feature of the optical connector; causing, based on identifying the other structural feature, the one or more adjustment components to adjust the microscope to another particular position such that the other structural feature of the optical connector is within the on-axis region of the field of view of the lens of the microscope; causing, based on causing the one or more adjustment components to adjust the microscope to the other particular position, the camera of the microscope to obtain one or more other images associated with the other structural feature of the optical connector; analyzing, using the first set of one or more analysis techniques, the one or more other images to generate other assessment information associated with the other structural feature of the optical connector; and providing the other assessment information.

In a third implementation, alone or in combination with one or more of the first and second implementations, the structural feature of the optical connector is associated with a first ferrule of the optical connector and the other structural feature of the optical connector is associated with a second ferrule of the optical connector.

In a fourth implementation, alone or in combination with one or more of the first through third implementations, the structural feature of the optical connector and the other structural feature of the optical connector are each associated with a single ferrule of the optical connector.

In a fifth implementation, alone or in combination with one or more of the first through fourth implementations, the structural feature includes at least one of an attachment component of the optical connector, or an edge of a ferrule of the optical connector.

In a sixth implementation, alone or in combination with one or more of the first through fifth implementations, each image, of the one or more images, includes a region associated with the on-axis region of the field of view of the lens of the microscope, and the region of the image shows the structural feature of the optical connector and does not show any of the set of one or more optical fibers of the optical cable.

In a seventh implementation, alone or in combination with one or more of the first through sixth implementations, each image, of the one or more images, includes a region associated with the on-axis region of the field of view of the lens of the microscope, and the region of the image shows the structural feature of the optical connector and at least a portion of one optical fiber of the set of one or more optical fibers of the optical cable.

In an eighth implementation, alone or in combination with one or more of the first through seventh implementations, providing the assessment information includes sending the assessment information to a display screen of the device, wherein sending the assessment to the display screen allows the display screen to display at least a portion of the assessment information.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for inspecting a set of one or more optical fibers included in an optical cable, the device comprising:
a microscope;
one or more adjustment components; and
one or more processors configured to:
determine that an optical connector is connected to the optical cable;
identify a structural feature of the optical connector;
cause, based on identifying the structural feature, the one or more adjustment components to adjust the microscope to a particular position such that the structural feature of the optical connector is within an on-axis region of a field of view of a lens of the microscope;
cause, based on causing the one or more adjustment components to adjust the microscope to the particular position, a camera of the microscope to obtain one or more images associated with the structural feature of the optical connector;
analyze, using a first set of one or more analysis techniques, the one or more images to generate assessment information associated with the structural feature of the optical connector; and
provide the assessment information.

2. The device of claim 1, wherein the one or more processors are further configured to:
identify a particular optical fiber of the set of one or more optical fibers;
cause, based on identifying the particular optical fiber, the one or more adjustment components to adjust the microscope to another particular position such that the particular optical fiber is within the on-axis region of the field of view of the lens of the microscope;
cause, based on causing the one or more adjustment components to adjust the microscope to the other particular position, the camera of the microscope to obtain one or more other images associated with the particular optical fiber;
analyze, using a second set of one or more analysis techniques, the one or more other images to generate other assessment information associated with the particular optical fiber; and
provide the other assessment information.

3. The device of claim 1, wherein the one or more processors are further configured to:
identify another structural feature of the optical connector;
cause, based on identifying the other structural feature, the one or more adjustment components to adjust the microscope to another particular position such that the other structural feature of the optical connector is within the on-axis region of the field of view of the lens of the microscope;
cause, based on causing the one or more adjustment components to adjust the microscope to the other particular position, the camera of the microscope to obtain one or more other images associated with the other structural feature of the optical connector;
analyze, using the first set of one or more analysis techniques, the one or more other images to generate other assessment information associated with the other structural feature of the optical connector; and
provide the other assessment information.

4. The device of claim 3, wherein the structural feature of the optical connector is associated with a first ferrule of the optical connector and the other structural feature of the optical connector is associated with a second ferrule of the optical connector.

5. The device of claim 3, wherein the structural feature of the optical connector and the other structural feature of the optical connector are each associated with a single ferrule of the optical connector.

6. The device of claim 1, wherein the structural feature includes at least one of:
an attachment component of the optical connector; or
an edge of a ferrule of the optical connector.

7. The device of claim 1, wherein each image, of the one or more images, includes a region associated with the on-axis region of the field of view of the lens of the microscope, and wherein the region of the image shows the structural feature of the optical connector and does not show any of the set of one or more optical fibers of the optical cable.

8. The device of claim 1, wherein each image, of the one or more images, includes a region associated with the on-axis region of the field of view of the lens of the microscope, and wherein the region of the image shows the structural feature of the optical connector and at least a portion of one optical fiber of the set of one or more optical fibers of the optical cable.

9. The device of claim 1, wherein the one or more processors, to provide the assessment information, are configured to:
send the assessment information to a display screen of the device,
wherein sending the assessment to the display screen allows the display screen to display at least a portion of the assessment information.

10. A device for inspecting a set of one or more optical fibers included in an optical cable, the device comprising:
a microscope;
one or more processors configured to:
identify a structural feature of an optical connector that is connected to the optical cable;
cause, based on identifying the structural feature, adjustment of the microscope to a particular position such that the structural feature of the optical connector is within an on-axis region of a field of view of a lens of the microscope;
cause, based on causing the adjustment of the microscope to the particular position, a camera of the microscope to obtain one or more images associated with the structural feature of the optical connector;
analyze the one or more images to generate assessment information associated with the structural feature of the optical connector; and
provide the assessment information.

11. The device of claim 10, wherein the one or more processors are further configured to:
cause adjustment of the microscope to another particular position such that a particular optical fiber, of the set of one or more optical fibers, is within the on-axis region of the field of view of the lens of the microscope;
cause, based on causing the adjustment of the microscope to the other particular position, the camera of the microscope to obtain one or more other images associated with the particular optical fiber;
analyze the one or more other images to generate other assessment information associated with the particular optical fiber; and
provide the other assessment information.

12. The device of claim 10, wherein the one or more processors are further configured to:
cause adjustment of the microscope to another particular position such that another structural feature of the optical connector is within the on-axis region of the field of view of the lens of the microscope;
cause, based on causing the adjustment of the microscope to the other particular position, the camera of the microscope to obtain one or more other images associated with the other structural feature of the optical connector;
analyze the one or more other images to generate other assessment information associated with the other structural feature of the optical connector; and
provide the other assessment information.

13. The device of claim 10, wherein each image, of the one or more images, includes a region associated with the on-axis region of a field of view of the lens of the microscope, and wherein the region of the image shows the structural feature of the optical connector and does not show any of the set of one or more optical fibers of the optical cable.

14. The device of claim 10, wherein each image, of the one or more images, includes a region associated with the on-axis region of the field of view of the lens of the microscope, and wherein the region of the image shows the structural feature of the optical connector and at least a portion of one optical fiber of the set of one or more optical fibers of the optical cable.

15. The device of claim 10, wherein the one or more processors, to provide the assessment information, are configured to:
send the assessment information to a display screen of the device to allow the display screen to display at least a portion of the assessment information.

16. A method, comprising:
causing, by a device for inspecting a set of one or more optical fibers included in an optical cable, adjustment of a microscope of the device to a particular position such that a structural feature of an optical connector that is connected to the optical cable is within an on-axis region of a field of view of a lens of the microscope;
analyzing, by the device and based on causing the adjustment of the microscope to the particular position, one or more images obtained by a camera of the microscope to generate assessment information associated with the structural feature of the optical connector; and
providing, by the device, the assessment information.

17. The method of claim 16, further comprising:
causing adjustment of the microscope to another particular position such that a particular optical fiber, of the set of one or more optical fibers is within the on-axis region of the field of view of the lens of the microscope;
analyzing, based on causing the adjustment of the microscope to the other particular position, one or more other images obtained by the camera of the microscope to generate other assessment information associated with the particular optical fiber; and
providing the other assessment information.

18. The method of claim 16, further comprising:
causing adjustment of the microscope to another particular position such that another structural feature of the optical connector is within the on-axis region of the field of view of the lens of the microscope;
analyzing, based on causing the adjustment of the microscope to the other particular position, one or more other images obtained by the camera of the microscope to generate other assessment information associated with the other structural feature of the optical connector; and
providing the other assessment information.

19. The method of claim 16, wherein each image, of the one or more images, includes a region associated with the on-axis region of the field of view of the lens of the microscope and wherein the region of the image shows the structural feature of the optical connector.

20. The method of claim 16, wherein providing the assessment information allows a display screen of the device to display at least a portion of the assessment information.
